(19) United States
(12) Patent Application Publication
(10) Pub. No.: US 2005/0030275 A1
(43) Pub. Date: Feb. 10, 2005

(54) Apparatus and method for processing signals

(76) Inventor: Su-Hyun Kwon, Suwon-si (KR)

Correspondence Address: MCGUIREWOODS, LLP, 1750 TYSONS BLVD, SUITE 1800, MCLEAN, VA, 22102, US

(21) Appl. No.: 10/889,145

(22) Filed: Jul. 13, 2004

(30) Foreign Application Priority Data
Jul. 14, 2003 (KR) 10-2003-47759

(51) Int. Cl. G09G 3/36

(52) U.S. Cl. 345/100

(57) ABSTRACT

An apparatus for processing signals is provided, which includes: a clock signal generator that produces first and second delayed clock signals with first and second delay times, respectively, based on an input clock signal; first and second processing blocks that process input signals and outputting output signals in synchronization with the first and the second clock signals, respectively.

### BACKGROUND OF THE INVENTION

(a) Field of the Invention

The present invention relates to an apparatus and method for processing signals, and in particular, to an apparatus and method for processing signals to reduce EMI by using clock modulation method and to a liquid crystal display including the apparatus for processing signals.

(b) Description of Related Art

Many electronic devices include microprocessors or digital circuits which use clock signals for synchronization. Clock signals provide accurate event timings for micro processors and digital circuits. Microprocessors and digital circuits using clock signals are apt to generate and emit electromagnetic interference (EMI), and the higher the speed of clock signals becomes, the larger the amount of EMI becomes.

EMI is generated by a conducting wire carrying high speed current and propagates in the air. EMI causes electronic devices to make errors and it has a bad influence upon the human body. Therefore, many countries are tightening the restrictions against EMI, and many manufacturers are keeping on an effort to follow the restrictions.

A liquid crystal display (LCD) is one of the most prevalent flat panel displays, which includes several conducting wires and circuits yielding EMI.

An LCD generally includes two panels having a plurality of electrodes for generating electric field, a liquid crystal (LC) layer interposed therebetween, and two polarization films attached to outer surfaces of the two panels. The LCD varies voltages applied to the field-generating electrodes to re-orient LC molecules in the LC layer, which determine polarization of light passing through the LC layer. The polarization films changes transmittance of the light based on the variation of the light polarization. Therefore, desired images are obtained by controlling the voltages applied to the field-generating electrodes.

The LCD also includes thin film transistors (TFTs) for switching the voltages applied to the field-generating electrodes, a plurality of signal lines for transmitting signals to the switching elements, and a plurality of digital circuits processing numerous digital data and converting the digital data into analog voltages using clocks, thereby generating EMI. Furthermore, the higher resolution of the LCD is, the more EMI is generated.

Generally, EMI is reduced by filtering, shielding, isolating noise coupling paths, and so on using filters, bypass capacitors, and so on. It is also required that paths of signal lines on a printed circuit board are determined in consideration of EMI. In addition, EMI may be also reduced by the frequency modulation of clock signals using a voltage controlled oscillator (VCO) or a phase locked loop (PLL).

However, the reduction of EMI increases production cost and requires much engineering efforts.

### SUMMARY OF THE INVENTION

It is a motivation of the present invention to solve the problems of the conventional art.

According to an aspect of the present invention, an apparatus for processing signals is provided, which includes: a clock signal generator that produces first and second delayed clock signals with first and second delay times, respectively, based on an input clock signal; first and second processing blocks that process input signals and outputting output signals in synchronization with the first and the second clock signals, respectively.

It is preferable that the input signal of the second processing block includes output signal of the first processing block, and the first delay time is longer than the second delay time so that the second processing block outputs the output signal in synchronization with the second clock signal with a timing margin.

The clock signal generator may include a plurality of transistors.

The output signal of the second processing block may be outputted an output signal of the apparatus, and the second delay time may be zero.

The apparatus may be included in a display device such as a liquid crystal display, a plasma display panel, and an organic light emitting display.

A method of processing signals is provided, which includes: generating a first clock signal delayed by a first delay time from the input clock signal; processing a first input signal in synchronization with the first clock signal to produce a first output signal; generating a second clock signal delayed by a second delay time from the input clock signal; and processing a second input signal in synchronization with the second clock signal to produce a second output signal.

It is preferable that the second input signal comprises the first output signal, and the first delay time is longer than the second delay time so that the first output signal is processed in synchronization with the second clock signal with a timing margin.

The first and the second delay times are obtained by a plurality of transistors.

The second delay time may be zero.

According to another aspect of the present invention, a signal processing apparatus for processing signals is provided, which includes: a clock signal generator that generates a first delayed clock signal delayed by a first delay time from an input clock signal, and generates a synthesized clock signal having a plurality of frequency components based on the input clock signal and the first delayed clock signal; and a processing block that receives the synthesized clock signal to process an input signal, wherein the synthesized clock signal includes alternately arranged first and second clock pulses in synchronization with the input clock signal and the first delayed clock signal, respectively.

It is preferable that the synthesized clock signal further includes a third clock pulse following the second clock pulse and synchronized with the input clock signal and a duration of the third clock pulse is substantially equal to a duration of a clock pulse of the input clock signal.

Preferably, the first delay time is determined so that the synthesized clock signal is allowable in the apparatus.

It is preferable that clock signal generator further generates a second delayed clock signal delayed by a second delay time from the input clock signal, the clock signal generator produces the synthesized clock signal further based on the second delayed clock signal, and the synthesized clock signal further includes a third clock pulse synchronized with the input clock signal and a fourth clock pulse synchronized with the second delayed clock signal.

Preferably, the first delay time and the second delay time are determined so that the synthesized clock signal is allowable in the apparatus.

The clock signal generator may include a plurality of transistors.

The apparatus may be included in a display device including a liquid crystal display, a plasma display panel, and an organic light emitting display.

A method of processing signals is provided, which includes: generating a first delayed clock signal delayed by a first delay time from the input clock signal; generating a synthesized clock signal having a plurality of frequency components based on the input clock signal and the first delayed clock signal; and processing an input signal in synchronization with the synthesized clock signal, wherein the synthesized clock signal includes alternately arranged first and second clock pulses in synchronization with the input clock signal and the first delayed clock signal, respectively.

It is preferable that the synthesized clock signal further includes a third clock pulse following the second clock pulse and synchronized with the input clock signal and a duration of the third clock pulse is substantially equal to a duration of a clock pulse of the input clock signal.

Preferably, the first delay time is determined so that the synthesized clock signal is allowable in the apparatus.

The method may further include: generating a second delayed clock signal delayed by a second delay time from the input clock signal, wherein the synthesized clock signal is generated further based on the second clock signal, and the synthesized clock signal further includes a third clock pulse synchronized with the input clock signal and a fourth clock pulse synchronized with the second delayed clock signal.

The first delayed clock signal is generated by a plurality of transistors.

A liquid crystal display is provided, which includes: a panel including a plurality of pixels, each pixel including a switching element; a gate driver that supplies first signals to the switching elements; a data driver that supplies second signals to the switching elements; and a signal controller that processes input image data in synchronization with at least a clock signal giving a plurality of timings and supplies the processed image data to the data driver.

The at least a clock signal may includes a plurality of delayed clock signals delayed in a sequential manner or a synthesized signal having a plurality of frequency components.

### BRIEF DESCRIPTION OF THE DRAWINGS

The present invention will become more apparent by describing embodiments thereof in detail with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIG. 3 is a block diagram of an apparatus for processing signals according to an embodiment of the present invention;

FIG. 4 is a timing diagram of exemplary clock signals and output signals of the first processing block in the apparatus shown in FIG. 3;

FIGS. 5A and 5B are graphs showing power consumption of a signal processing apparatus using a single clock signal and using a plurality of sequentially delayed clock signals, respectively.

FIG. 6 is a block diagram of an apparatus for processing signals according to another embodiment of the present invention;

FIG. 7 is a timing diagram of various examples of synthesized clock signals according to an embodiment of the present invention;

FIG. 8A is a graph showing power consumption of a signal processing apparatus using a clock signal having a single frequency component; and

FIGS. 8B-8E are graphs showing power consumption of a signal processing apparatus using a synthesized clock signal having two to five frequency components, respectively.

### DETAILED DESCRIPTION OF THE PREFERRED EMBODIMENTS

The present invention now will be described in more detail hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Now, liquid crystal displays including apparatus for processing signals according to embodiments of the present invention will be described in detail with reference to the accompanying drawings.

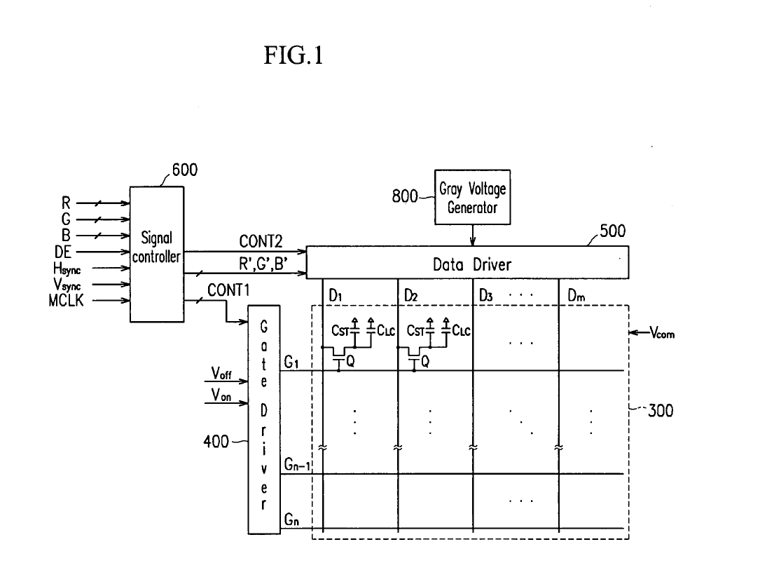

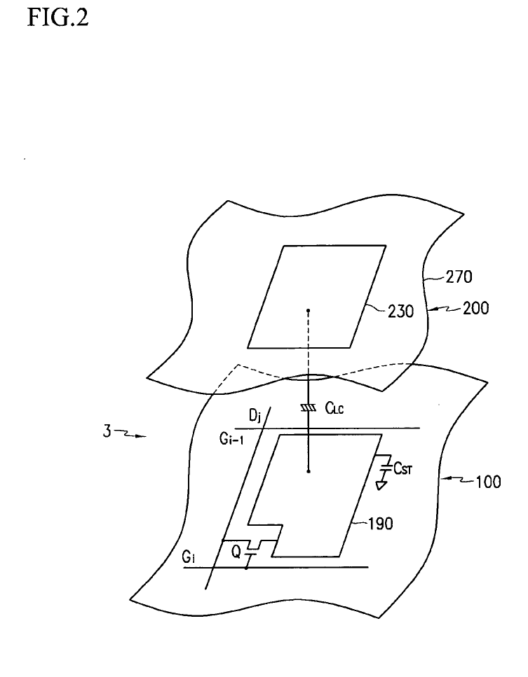

An LCD according to an embodiment of the present invention will be described in detail with reference to FIGS. 1 and 2.

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes a LC panel assembly 300, a gate driver 400 and a data driver 500 that are connected to the panel assembly 300, a gray voltage generator 800 connected to the data driver 500, and a signal controller 600 controlling the above elements.

In circuital view, the panel assembly 300 includes a plurality of display signal lines Gₗ-Gₙ and Dₗ-Dₘ and a plurality of pixels connected thereto and arranged substantially in a matrix.

The display signal lines Gₗ-Gₙ and Dₗ-Dₘ include a plurality of gate lines Gₗ-Gₙ transmitting gate signals (also referred to as “scanning signals”), and a plurality of data lines Dₗ-Dₘ transmitting data signals. The gate lines Gₗ-Gₙ extend substantially in a row direction and substantially parallel to each other, while the data lines Dₗ-Dₘ extend substantially in a column direction and substantially parallel to each other.

Each pixel includes a switching element Q connected to the signal lines Gₗ-Gₙ and Dₗ-Dₘ, and a LC capacitor C_{LC} and a storage capacitor C_{ST} that are connected to the switching element Q. The storage capacitor C_{ST} may be omitted if unnecessary.

The switching element Q is provided on a lower panel 100 and it has three terminals: a control terminal connected to one of the gate lines Gₗ-Gₙ; an input terminal connected to one of the data lines Dₗ-Dₘ; and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q and the common electrode 270 is connected to the common voltage V_{com} and covers entire surface of the upper panel 200. Unlike FIG. 2, the common electrode 270 may be provided on the lower panel 100, and both electrodes 190 and 270 may have shapes of bar or stripes.

The storage capacitor C_{ST} is defined by the overlap of the pixel electrode 190 and a separate wire (not shown) provided on the lower panel 100 and applied with a predetermined voltage such as the common voltage V_{com}. Otherwise, the storage capacitor is defined by the overlap of the pixel electrode 190 and its previous gate line Gᵢ₋ₗ via an insulator.

For color display, each pixel can represent its own color by providing one of a plurality of red, green and blue color filters 230 in an area corresponding to the pixel electrode 190. The color filter 230 shown in FIG. 2 is provided in the corresponding area of the upper panel 200. Alternatively, the color filters 230 are provided on or under the pixel electrode 190 on the lower panel 100.

A polarizer or polarizers (not shown) are attached to at least one of the panels 100 and 200 to polarize the light.

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 is connected to the gate lines Gₗ-Gₙ, of the panel assembly 300 and applies gate signals from an external device to the gate lines Gₗ-Gₙ. The gate signal is a combination of a gate-on voltage Von and a gate-off voltage Voff.

The data driver 500 is connected to the data lines Dₗ-Dₘ of the panel assembly 300 and selects gray voltages from the gray voltage generator 800 to apply as data signals to the data lines Dₗ-Dₘ.

The gate driver 400 or the data driver 400 may include a plurality of driver integrated circuit (ICs) that are mounted directly on the panel assembly 300 or mounted on flexible printed circuit films to form tape carrier packages attached to the panel assembly 300. Alternatively, the gate driver 400 or the data driver 500 may be integrated into the panel assembly.

The signal controller 600 controls the gate driver 400, the data driver 500, and so on.

Next, the operation of the LCD will be described in detail.

The signal controller 600 is supplied from an external graphic controller (not shown) with input image signals R, G and B and input control signals controlling the display thereof, for example, a vertical synchronization signal Vsync, a horizontal synchronization signal Hsync, a main clock signal MCLK, a data enable signal DE, etc. The signal controller 600 modifies the input image signals R, G and B based on the operating condition of the panel assembly 300 and provides the modified image signals R′, G′ and B′ for the data driver 500. Moreover, the signal controller 600 generates a plurality of gate control signals CONT1 and data control signals CONT2 on the basis of the input image signals and the input control signals and it provides the gate control signals CONT1 for the gate driver 400 and the data control signals CONT2 for the data driver 500.

The gate control signals CONT1 include a scanning start signal STV for instructing to start the scanning of the gate-on voltage Von and at least a clock signal for controlling the output timing of the gate-on voltage Von.

The data control signals CONT2 include a horizontal synchronization start signal STH for informing of data transmission for a pixel row, a load signal LOAD or TP for instructing to apply the data voltages to the data lines D₁-Dₘ, an inversion control signal RVS for reversing the polarity of the data voltages (with respect to the common voltage Vcom), and a data clock signal HCLK.

The data driver 500 receives a packet of the image data R′, G′ and B′ for a pixel row from the signal controller 600. The data driver 500 converts the image data R′, G′ and B′ into analog data voltages selected from the gray voltages from the gray voltage generator 800 and applies the data voltages to the data lines Dₗ-Dₘ in response to the data control signals CONT2 from the signal controller 600.

Responsive to the gate control signals CONT1 from the signal controller 600, the gate driver 400 applies the gate-on voltage Von to the gate line Gₗ-Gₙ, thereby turning on the switching elements Q connected thereto. The data voltages applied to the data lines Dₗ-Dₘ are supplied to the corresponding pixels via the turned-on switching elements Q.

By repeating this procedure by a unit of a horizontal period (which is also denoted by “1H” and equal to one periods of the horizontal synchronization signal Hsync and the data enable signal DE), all gate lines Gₗ-Gₙ are sequentially supplied with the gate-on voltage Von during a frame, thereby applying the data voltages to all pixels. When the next frame starts after finishing one frame, the inversion control signal RVS applied to the data driver 500 is controlled such that the polarity of the data voltages is reversed (which is called “frame inversion”). The inversion control signal RVS may be also controlled such that the polarity of the data voltages flowing through a data line in one frame are reversed (e.g., line inversion and dot inversion), or the polarity of the data voltages in one packet are reversed (e.g., column inversion and dot inversion).

Now, apparatus for processing signals including the signal controller shown in FIG. 1 according to embodiments of the present invention will be described in detail.

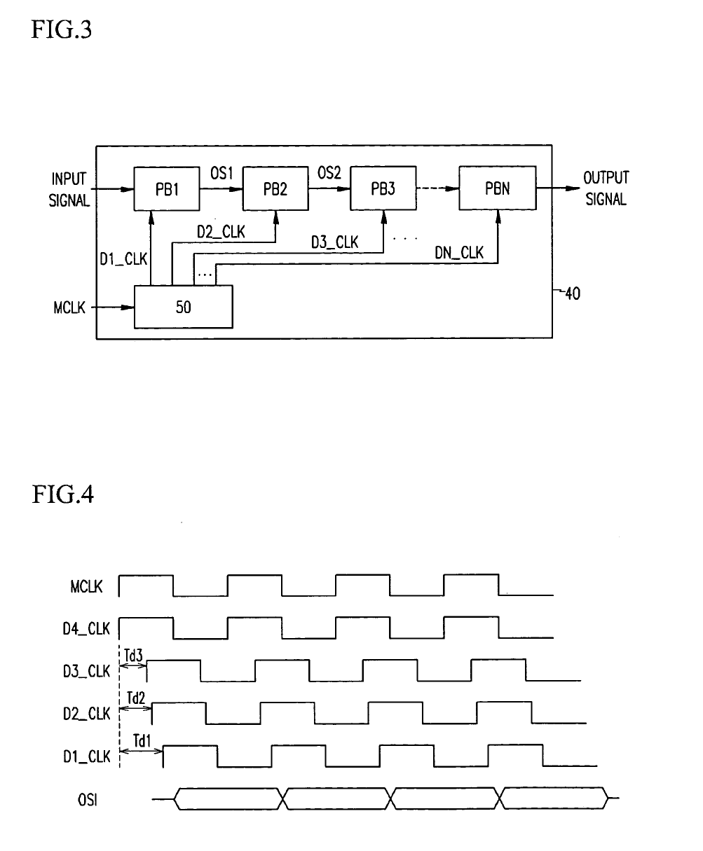

First, a signal processing apparatus using a plurality of asynchronous clock signals according to an embodiment of the present invention will be described is detail with reference to FIGS. 3-5B.

FIG. 3 is a block diagram of an apparatus for processing signals according to an embodiment of the present invention.

Referring to FIG. 3, the signal processing apparatus 40 includes a clock signal generator 50 and first to N-th (N=2, 3, . . . ) processing blocks PB1-PBN connected thereto. Here, the apparatus 40 may correspond to the above-described signal controller 600 and the N processing blocks PB1-PBN may correspond to processing blocks in the signal controller 600.

The clock signal generator 50 receives a main clock signal MCLK and produces a plurality of clock signals D1_CLK to DN_CLK that are delayed in a reverse sequential manner and the number of the clock signals DN1_CLK to DN_CLK generated by the clock signal generator 50 is equal to the number of the processing blocks PB1-PBN.

The clock signal generator 50 includes a delay block (not shown) for producing the clock signals DN1_CLK to DN_CLK, which includes a delay circuit including a plurality of transistors. This delay circuit generates the clock signals DN1_CLK to DN_CLK using the time delay for the transistors to pass input signals.

Each of the processing blocks PB1-PBN receives and processes input signals from an external device or a previous processing block and generates output signals OS1-OSN in a sequential or cascaded manner and in synchronization with rising edges or falling edges of one of the clock signals DN1_CLK to DN_CLK from the clock signal generator 50. In particular, the first processing block PB1 receives input signals from an external device, and the output signals OSN of the last processing block PBN is outputted as output signals of the apparatus 40.

Each processing block PB1-PBN may receive and process input signals from the external device to supply its output signals to other processing blocks or another device external to the apparatus 40.

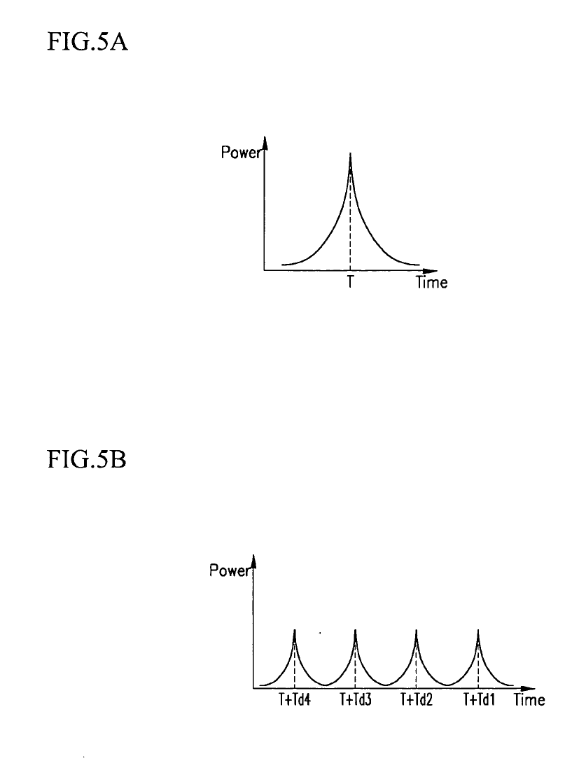

FIG. 4 is a timing diagram of exemplary clock signals and output signals of the first processing block in the apparatus shown in FIG. 3. For descriptive convenience, it is assumed that N is equal to four.

As shown in FIG. 4, the clock signals D1_CLK, D2_CLK, D3_CLK and D4_CLK are delayed by delay times Td1, Td2, Td3 and Td4 from the main clock signal MCLK, respectively.

The delay times are preferably set to satisfy:
Td4<Td3<Td2<Td1. (1)

To generalize, the clock signal D1_CLK supplied to the first processing block PB1, which processes the input signals first, has the longest delay time, and the clock signal DN_CLK supplied to the last processing block PBN, which processes the input signals last, has the shortest delay time.

In the meantime, the delay times are also set in consideration of setup time and hold time for normal operation of the processing blocks PB1-PBN. The setup time is defined as a minimum time interval that an input signal should reach a stable state before an active clock pulse is asserted, and the hold time is defined as a minimum time interval that the input signal maintains its stable state after the active clock pulse is asserted. When each delay time is determined like this, each processing block PB1-PBN can process the input signals in synchronization with the clock signal D1_CLK to DN_CLK with a timing margin.

The delay times may be determined so that the time intervals between rising edges of neighboring two clock signals are constant. Alternatively, the delay times may be separately set depending on the power consumption in the respective processing blocks using the delayed clock signals. In other words, the delay times are determined so that a rising edge of a clock signal for a processing block with large power consumption may be far from those for adjacent processing blocks. This reduces a maximum power consumed by the processing block with large power consumption, thereby reducing EMI much more.

The delay time of the last delayed clock signal for the last processing block PBN may be set to zero for minimizing the size of the delay circuit. In other words, the last processing block PBN uses the main clock signal MCLK as it is.

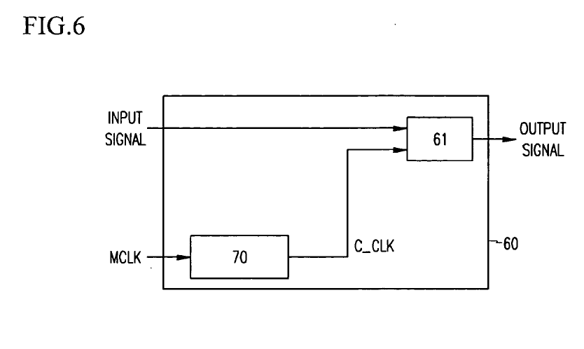

FIGS. 5A and 5B are graphs showing power consumption of a signal processing apparatus using a single clock signal and using a plurality of sequentially delayed clock signals, respectively.

Referring to FIG. 5A, since all processing blocks simultaneously operate in synchronization with a single clock signal, the power consumption is concentrated at a time T. Therefore, a peak value of the consumed power is relatively high, thereby generating relatively strong EMI.

Referring to FIG. 5B, the processing blocks operate at different times using respective clock signals that give different synchronization timings, the power consumption is dispersed in time. Therefore, the power consumption has a plurality of peaks spread at several times T+Td4, T+Td3, T+Td2 and T+Td1, and the peak values are lower than the peak value shown in FIG. 5A. Accordingly, the EMI is reduced.

Accordingly, the signal processing apparatus according to this embodiment uses a plurality of asynchronous clock signals to disperse the power consumption in time domain, thereby decreasing the peak values of the consumed power to reduce the EMI.

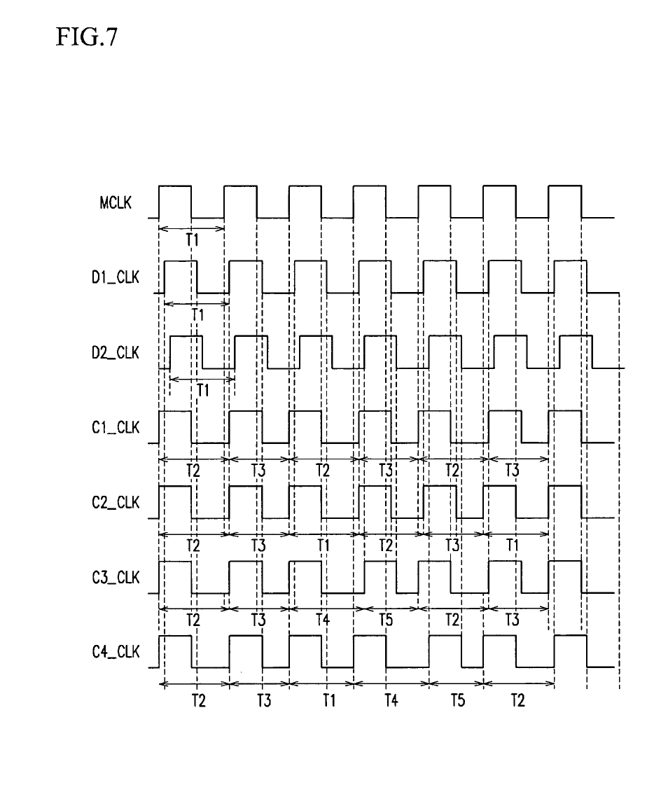

Now, a signal processing apparatus using a synthesized clock signal with a plurality of frequency components according to an embodiment of the present invention will be described in detail with reference to FIGS. 6-8E.

FIG. 6 is a block diagram of an apparatus for processing signals according to another embodiment of the present invention.

Referring to FIG. 6, a signal processing apparatus 60 according to this embodiment includes a clock signal generator 70 and a processing block 61 connected thereto. Here, the apparatus 60 may correspond to the signal controller 600 shown in FIG. 1.

The clock signal generator 70 includes a delay block (not shown) producing one or more delayed clock signals based on the main clock MCLK, and generates a synthesized clock signal C_CLK having a plurality of frequency components based on the main clock MCLK and the delayed clock signals. The number of the frequency components in the synthesized signal C_CLK may be determined according to the system requirement.

The processing block 61 receives and processes input signals in synchronization with the synthesized clock signal clock C-CLK.

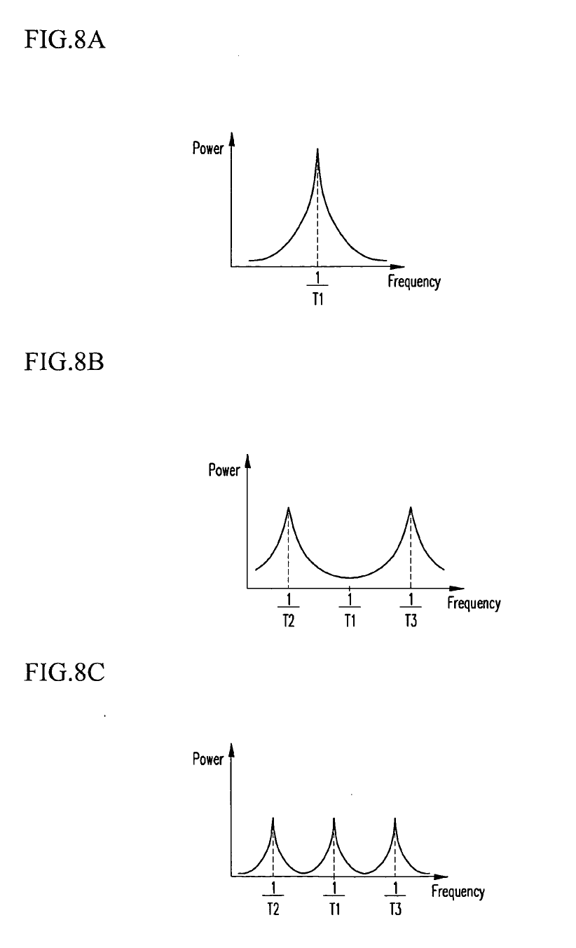

Referring to FIG. 7, examples of the synthesized clock signals will be described in detail.

FIG. 7 is a timing diagram of various examples of synthesized clock signals according to an embodiment of the present invention.

Referring to FIG. 7, D1_CLK and D2_CLK indicate first and second delayed clock signals that are delayed by delay times Td1 and Td2 from the main clock signal MCLK, respectively. The periods of the main clock signal MCLK and the delayed clock signals D1_CLK and D2_CLK are equal to T1 and the delay times Td1 and Td2 are determined in consideration of setup and hold times for normal operation of the processing block 61.

A clock signal C1_CLK having two frequency components includes alternately arranged two clock pulses. One of the two clock pulses is synchronized with the main clock signal MCLK and the other of the two clock pulses is synchronized with the first delayed clock signal D1_CLK. Accordingly, the time intervals between successive two rising edges or falling edges are alternately equal to T2 and T3, where T2=T1+Td1 and T3=T1−Td1.

A clock signal C2_CLK having three frequency components includes three clock pulses arranged in turn. Two of the three clock pulses are synchronized with the main clock signal MCLK and a remaining one of the three clock pulses is synchronized with the first 10 delayed clock signal D1_CLK. Accordingly, the time intervals between successive two rising edges or falling edges are equal to T2, T3, and T1 in turn.

A clock signal C3_CLK having four frequency components four clock pulses arranged in turn. two of the four clock pulses are synchronized with the main clock signal MCLK, another of the four clock pulses is synchronized with the first delayed clock signal D1_CLK, and a remaining one of the four clock pulses is synchronized with the second delayed clock signal D2_CLK. The two of the four clock pulses that are synchronized with the main clock are not adjacent. Accordingly, the time intervals between successive two rising edges or falling edges are equal to T2, T3, T4, and T5 in turn, where T4=T1+Td2 and T5=T1-Td2.

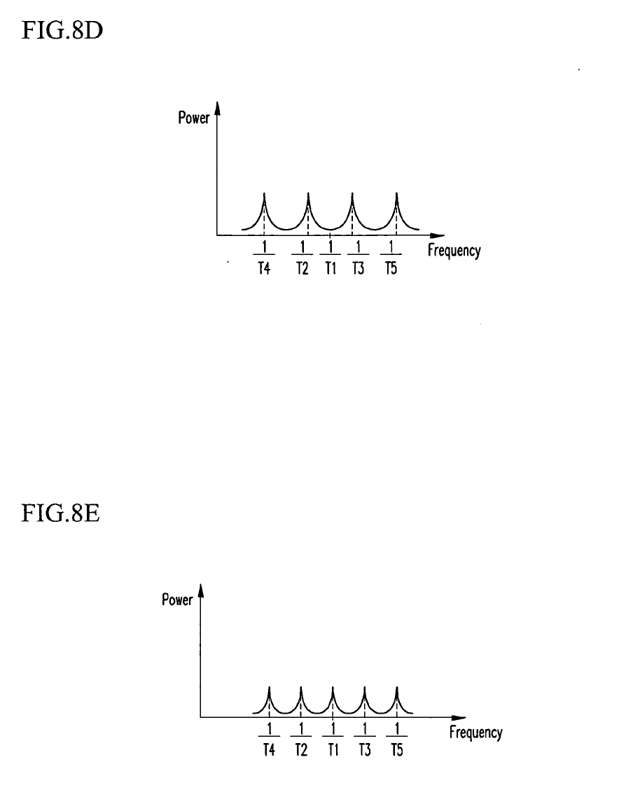

A clock signal C4_CLK having five frequency components have the time intervals T2, T3, T1, T4, and T5 between successive two rising edges or falling edges arranged in turn. The clock signal C4_CLK is obtained by inserting one clock pulse synchronized with the main clock signal MCLK between two of the four clock pulses in the synthesized clock signal C3_CLK. In FIG. 8, the third clock pulse indicates the inserted clock pulse.

A synthesized clock signal having six or more frequency components can be also obtained in a similar way.

FIG. 8A is a graph showing power consumption of a signal processing apparatus using a clock signal having a single frequency component and FIGS. 8B-8E are graphs showing power consumption of a signal processing apparatus using a synthesized clock signal having two to five frequency components, respectively.

Referring to FIG. 8A, since a processing block operates only in synchronization with a clock signal MCLK having a frequency 1/T1, the power consumption is concentrated at the frequency 1/T1. Therefore, a peak value of the consumed power appearing at the frequency 1/T1 becomes relatively high, thereby generating relatively strong EMI.

However, FIGS. 8B-8E show dispersive power consumption in the case that the processing block 61 operates in synchronization with a synthesized clock signal having two to five frequency components. The number of the peaks in the graphs increases in proportion to the number of the frequency components in the synthesized clock signal. The peak values become small as the number of the peaks becomes large. Accordingly, the EMI is reduced.

Accordingly, the signal processing apparatus according to this embodiment uses a synthesized clock signal having a plurality of frequency components to disperse the power consumption in frequency domain, thereby decreasing the peak values of the consumed power to reduce the EMI.

To summarize, the signal processing apparatus according to the embodiments of the present invention generates less EMI by using several asynchronous clock signals or a synthesized clock signal having several frequency components.

As described, the signal processing apparatus illustrated with reference to FIGS. 3-8E can be employed as the signal controller of the LCD shown in FIGS. 1 and 2. However, it may be also adapted to any electronic device such as flat panel displays including a plasma display panel and an organic light emitting display.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. An apparatus for processing signals, the apparatus comprising:
a clock signal generator that produces first and second clock signals with first and second delay times, respectively, based on an input clock signal; and
first and second processing blocks that process input signals and outputting output signals in synchronization with the first and the second clock signals, respectively.

2. The apparatus of claim 1, wherein the input signal of the second processing block comprises the output signal of the first processing block, and the first delay time is longer than the second delay time so that the second processing block outputs the output signal in synchronization with the second clock signal with a timing margin.

3. The apparatus of claim 2, wherein the clock signal generator comprises a plurality of transistors.

4. The apparatus of claim 2, wherein the output signal of the second processing block is outputted as an output signal of the apparatus, and the second delay time is zero.

5. A display device comprising the apparatus of claim 1.

6. The display device of claim 5, wherein the display device comprises one of a liquid crystal display, a plasma display panel, and an organic light emitting display.

7. A method of processing signals, the method comprising:
generating a first clock signal delayed by a first delay time from an input clock signal;
processing a first input signal in synchronization with the first clock signal to produce a first output signal;
generating a second clock signal delayed by a second delay time from the input clock signal; and
processing a second input signal in synchronization with the second clock signal to produce a second output signal.

8. The method of claim 7, wherein the second input signal comprises the first output signal, and the first delay time is longer than the second delay time so that the first output signal is processed in synchronization with the second clock signal with a timing margin.

9. The method of claim 8, wherein the first and the second delay time is obtained by a plurality of transistors.

10. The method of claim 8, wherein the second delay time is zero.

11. A signal processing apparatus comprising:
a clock signal generator that generates a first delayed clock signal delayed by a first delay time from an input clock signal, and generates a synthesized clock signal having a plurality of frequency components based on the input clock signal and the first delayed clock signal; and
a processing block that receives the synthesized clock signal to process an input signal,
wherein the synthesized clock signal includes alternately arranged first and second clock pulses in synchronization with the input clock signal and the first delayed clock signal, respectively.

12. The apparatus of claim 11, wherein the synthesized clock signal further includes a third clock pulse following the second clock pulse and synchronized with the input clock signal and a duration of the third clock pulse is substantially equal to a duration of a clock pulse of the input clock signal.

13. The apparatus of claim 12, wherein the first delay time is determined so that the synthesized clock signal is allowable in the apparatus.

14. The apparatus of claim 12, wherein the clock signal generator further generates a second delayed clock signal delayed by a second delay time from the input clock signal,
the clock signal generator produces the synthesized clock signal further based on the second delayed clock signal, and
the synthesized clock signal further includes a third clock pulse synchronized with the input clock signal and a fourth clock pulse synchronized with the second delayed clock signal.

15. The apparatus of claim 14, wherein the first delay time and the second delay time are determined so that the synthesized clock signal is allowable in the apparatus.

16. The apparatus of claim 12, wherein the clock signal generator comprises a plurality of transistors.

17. A display device comprising the apparatus of claim 11.

18. The display device of claim 17, wherein the display device comprises one of a liquid crystal display, a plasma display panel, and an organic light emitting display.

19. A method of processing signals, the method comprising:
generating a first delayed clock signal delayed by a first delay time from the input clock signal;
generating a synthesized clock signal having a plurality of frequency components based on the input clock signal and the first delayed clock signal; and
processing an input signal in synchronization with the synthesized clock signal,
wherein the synthesized clock signal includes alternately arranged first and second clock pulses in synchronization with the input clock signal and the first delayed clock signal, respectively.

20. The method of claim 19, wherein the synthesized clock signal further includes a third clock pulse following the second clock pulse and synchronized with the input clock signal and a duration of the third clock pulse is substantially equal to a duration of a clock pulse of the input clock signal.

21. The method of claim 20, wherein the first delay time is determined so that the synthesized clock signal is allowable in the apparatus.

22. The method of claim 20, further comprising:
generating a second delayed clock signal delayed by a second delay time from the input clock signal,
wherein the synthesized clock signal is generated further based on the second clock signal, and
the synthesized clock signal further includes a third clock pulse synchronized with the input clock signal and a fourth clock pulse synchronized with the second delayed clock signal.

23. The method of claim 20, wherein the first delayed clock signal is generated by a plurality of transistors.

24. A liquid crystal display comprising:
a panel including a plurality of pixels, each pixel including a switching element;
a gate driver that supplies first signals to the switching elements;
a data driver that supplies second signals to the switching elements; and
a signal controller that processes input image data in synchronization with at least a clock signal giving a plurality of timings and supplies the processed image data to the data driver.

25. The liquid crystal display of claim 24, wherein the at least a clock signal includes a plurality of delayed clock signals delayed in a sequential manner.

26. The liquid crystal display of claim 24, wherein the at least a clock signal includes a synthesized signal having a plurality of frequency components.
